(19) United States
(12) Patent Application Publication
(10) Pub. No.: US 2025/0024997 A1
(43) Pub. Date: Jan. 23, 2025

(54) METHOD AND APPARATUS FOR DISLODGING COFFEE IN COFFEE GRINDERS

(71) Applicant: Shauvik Gayen, Surrey Hills (AU)

(72) Inventor: Shauvik Gayen, Surrey Hills (AU)

(21) Appl. No.: 18/761,346

(22) Filed: Jul. 2, 2024

Related U.S. Application Data
(60) Provisional application No. 63/528,378, filed on Jul. 22, 2023.

(51) Int. Cl. A47J 42/06; A47J 42/40

(52) U.S. Cl. CPC A47J 42/06; A47J 42/40

(57) ABSTRACT

A method and apparatus for dislodging coffee in coffee grinders includes a coffee grinding chamber housing the burrs that is allowed to move relative to the coffee grinder body, and a spring mechanism. The user first retracts the spring mechanism moving the grinding chamber away from its fully locked position and then releases the spring mechanism inducing a sudden acceleration and deceleration of the entire grinding chamber relative to the grinder body, dislodging coffee into the grinding burrs in the grinding chamber or off the grinding chamber into the grounds collection vessel.

### BACKGROUND OF THE INVENTION

Current coffee grinders often suffer two key challenges. These are especially problematic when users dose in a specific amount of coffee by weight or volume and expect the same or a similar amount of ground coffee to come out of or off of the grinder.

Unground coffee often gets stuck before entering the grinding burrs in the grinding chamber. Current solutions for dislodging stuck unground coffee include elastomeric manual pumps that blow air into the grinding chamber. The movement of air is usually able to move these unground coffee particles into the grinding burrs but is often unsuccessful and the user experience can be frustrating. The elastomeric manual pump can also add significant bulk to the overall coffee grinder.

Ground coffee particles coming out of or off the grinding burrs in the grinding chamber often cling to the grinding chamber instead of falling into the ground coffee collection vessel. Current solutions for dislodging ground coffee particles involve spring driven knockers that rely on inducing a rapid movement, upon spring driven impact, to the chute that directs ground coffee particles to the ground coffee collection vessel. While this method is effective in releasing ground coffee stuck to the chute, it is not effective in removing coffee grounds that are stuck to the burrs and the grinding chamber that houses the burrs. Elastomeric manual pumps can also be used to target this problem, however, they rely on air movement to dislodge coffee particles and are often not effective enough.

While current coffee knocking solutions in grinders rely on moving air

through the grinding chamber or knocking the chute that directs ground coffee out of or off the grinding chamber, none are designed to induce a short and quick movement of the grinding chamber within the grinder frame. That is, the grinding chamber is normally fixed within the grinder frame when the knocker is used.

Users often knock the entire grinder body and move the entire grinder body to solve these two problems. Not only is this a poor user experience, such knocking may also cause damage to the grinder.

### SUMMARY OF THE INVENTION

By allowing the grinding chamber to move within the grinder frame and using a spring driven mechanism to impart a sudden acceleration or deceleration to the grinding chamber, the ability to dislodge coffee in grinders is improved creating a better user experience.

The disclosed exemplary embodiments provide an apparatus for the dislodging of coffee in coffee grinder applications.

In one embodiment, the spring mechanism, when charged by the user, rotates the grinding chamber away from the resting position and when released by the user, imparts a sudden acceleration and deceleration to the grinding chamber. This embodiment provides an effective means for dislodging of coffee in coffee grinder applications.

Further objects, features, advantages and properties of the method and apparatus will become apparent from the detailed description.

### BRIEF DESCRIPTION OF DRAWINGS

In the following detailed portion of the present description, the teachings of the present application will be explained in more detail with reference to the example embodiments shown in the drawings, in which:

FIG. 1 is an isometric view of a set of apparatus according to a first embodiment,

FIG. 2 is a cross section view of a set of apparatus according to a first embodiment,

FIG. 3 is a close-up view of a set of apparatus according to a first embodiment of the spring mechanism and grinding chamber components of the present application.

### DETAILED DESCRIPTION OF THE INVENTION

In the following detailed description, the method and the apparatus according to the teachings for this application in the form of a coffee grinder including a grinding chamber that is held by the grinder body and allowed to move relative to the grinder body along with a spring mechanism will be described by the embodiments.

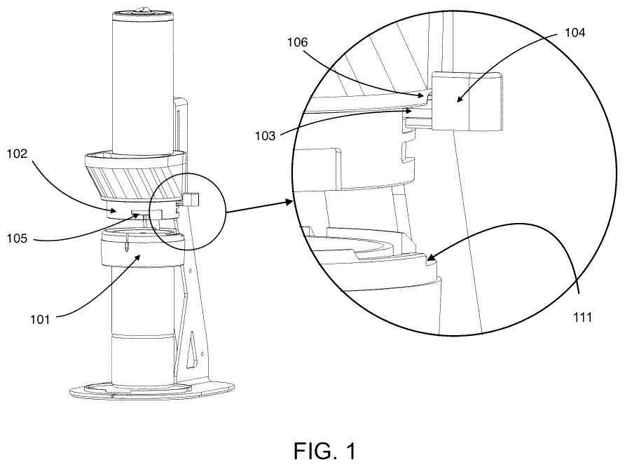

An isometric view of an embodiment of the apparatus according to the teachings for this application is illustrated in FIG. 1. The grinding chamber (101) is shown unmounted from the grinder body (102) and can be supported by the grinder body (102) through a set of lock features (105) on the grinder body (102) and a mating set of lock features (105) on the grinding chamber (101). In this embodiment the lock features are a bayonet style set of slots (105) on the grinder body (102) that support the grinding chamber (101) with matching tabs that fit into the lock features (105). In this embodiment, when supported by the grinder body (102), the grinding chamber (101) is free to move in at least one axis. In this embodiment the primary axis of movement is rotation along the rotation axis of the burrs in the grinding chamber (101) or the rotational axis of the cylindrical body of the grinding chamber (101). The spring mechanism, in this embodiment, comprises a spring (103), shown in its rest position, and optionally a set of parts that constitute the tab (104). In this embodiment, the spring mechanism can be moved away from its rest position, against the force of the spring using the tab (104) in the course of which the grinding chamber (101) is rotated away by a slight rotational movement from its fully locked position when supported by the grinder body (102) using the lock features (105).

Once the spring mechanism is released, in this embodiment, the spring mechanism moves back towards its original position, ultimately knocking the grinding chamber (101) back into its fully locked position by impacting the forward edge (111) on the grinding chamber (101), resulting in a rapid acceleration and then a rapid deceleration of the grinding chamber (101). In this embodiment, the grinder body (102) also includes a notch (106) for the spring mechanism to move up into as the grinding chamber (101) is locked into the grinder body (102).

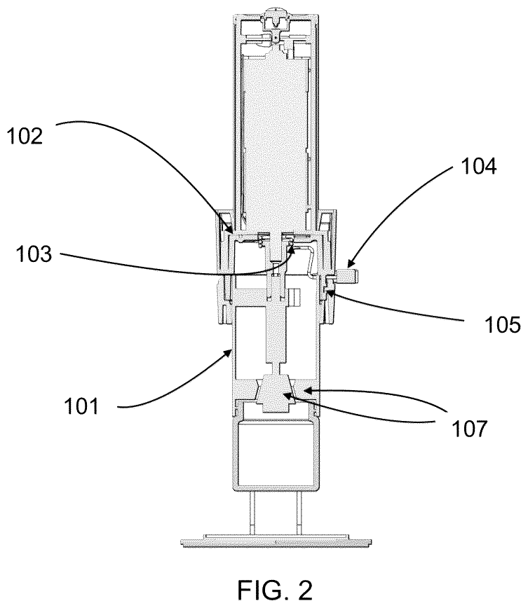

A cross section view of an embodiment of the apparatus according to the teachings for this application is illustrated in FIG. 2. Here, the grinding chamber (101) is shown supported by the grinder body (102) through a set of lock features (105) on the grinder body (102) and a mating set of lock features (105) on the grinding chamber (101). In this embodiment the lock features (105) are a bayonet style set of slots on the grinder body (102) that support the grinding chamber (101) with mating tabs that fit into the set of slots. In this embodiment, when supported by the grinder body (102), the grinding chamber (101) is free to move in at least one axis. In this embodiment the primary axis of movement is rotation along the rotation axis of the burrs (107) in the grinding chamber (101). The spring mechanism, in this embodiment, comprises a spring (103), shown in its rest position, and optionally a set of parts that constitute the tab (104). In this embodiment, the spring mechanism can be moved away from its rest position, against the force of the spring using the tab (104), in the course of which the grinding chamber (101) is rotated away by a slight rotational movement from its fully locked position when supported by the grinder body (102) using the lock features (105). Once the spring mechanism is released, in this embodiment, the spring mechanism moves back towards its original position, ultimately knocking the grinding chamber (101) back into its fully locked position, resulting in a rapid acceleration and then a rapid deceleration of the grinding chamber (101). In this embodiment, the grinder body (102) also includes a notch (106) for the spring mechanism to move up into as the grinding chamber (101) is locked into the grinder body (102).

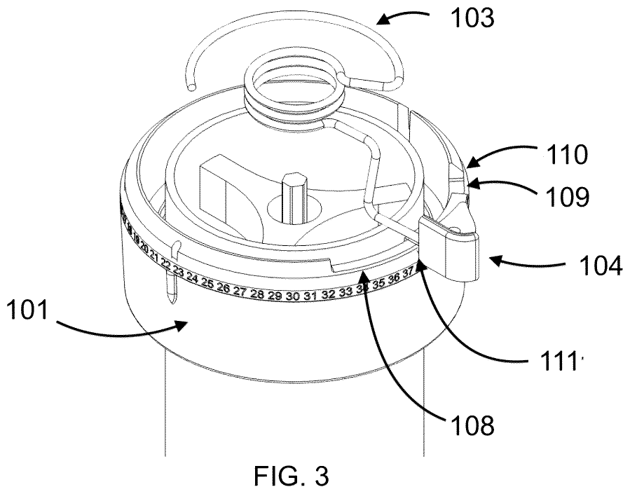

A close-up view of a possible embodiment of the apparatus according to the teachings for this application with only the spring mechanism and grinding chamber visible is illustrated in FIG. 3. In this view, the grinding chamber (101) is shown along with the spring member (103) of the spring mechanism and optionally a set of parts constituting the tab (104) of the spring mechanism. Here, additional features that allow the grinding chamber to lock into the device unimpeded by the spring mechanism are shown such as,
a ledge (108) for the tab (104) of the spring mechanism to sit on as the grinding chamber (101) is locked into the grinder body and when the grinding chamber (101) is removed from the grinder body,
a ledge (109) for the tab (104) of the spring mechanism to sit on when the spring mechanism is moved away from its resting state,
the opposing edge (110) on the grinding chamber (101) for the tab (104) of the spring mechanism to push back into and move the grinding chamber (101) away from its fully locked position when supported by the grinder body,
the impact edge (111) on the grinding chamber (101) for the tab (104) of the spring mechanism to impact upon release of the spring mechanism.

1. A method of dislodging coffee into the grinding burrs of the grinding chamber and out of or off the grinding chamber comprising,
providing a grinding chamber, wherein grinding burrs are housed and wherein lock features allow the grinding chamber to be supported by the main grinder body,
providing a grinder body, wherein lock features matching lock features on the grinding chamber allow the grinder body to support the grinding chamber while allowing the grinding chamber to move in at least one axis,
providing a spring mechanism or a combination of spring mechanisms that are capable of
moving the grinding chamber away from the fully locked position of the mating lock features in said grinder body while said grinding chamber is supported by the grinder body and
inducing a rapid acceleration and deceleration of the grinding chamber relative to the grinder body,
moving said spring mechanism or combination of spring mechanisms away from their resting state, wherein said mechanism or combination of spring mechanisms moves said grinding chamber away from the fully locked position of the lock mechanism while supported by said grinder body and,
releasing said spring mechanism or combination of spring mechanisms, in order to allow said spring mechanism or combination of spring mechanisms to revert back towards its resting state and in the course of doing so transfer a mechanical shock to the grinding chamber, inducing a rapid acceleration and deceleration movement of the grinding chamber relative to the grinder body.

2. Apparatus for dislodging coffee in coffee grinders comprising,
a grinding chamber that houses the grinding burrs and includes features that allow it to be held by the grinder body,
a grinder body with lock features that support the grinding chamber within the grinder frame but also allows for movement of the grinder chamber relative to the grinder body in a single axis or a combination of multiple axes and,
a spring mechanism or combination of spring mechanisms, which when pushed away from its resting position by the user, moves the entire grinding chamber away from the end position of the lock features to then, upon release by the user, induces a mechanical shock to the grinding chamber and results in a small rapid movement of the grinding chamber towards the end position of the lock features causing both unground coffee to fall into the grinding chamber and ground coffee to fall out of or off the grinding chamber.

3. Apparatus for dislodging coffee in coffee grinders according to claim 2, wherein the lock features comprise of one or more bayonet style lock features, wherein the primary axis of movement of the grinding chamber within the frame of the grinder body for dislodging coffee is rotation along the axis of rotation of the grinding burrs in the grinding chamber.

4. Apparatus for dislodging coffee in coffee grinders according to claim 2 wherein the lock features comprise of one or more slots that allow movement of the grinding chamber within the frame of the grinder body primarily parallel to the axis of the rotation of the grinding burrs in the grinding chamber.

5. Apparatus for dislodging coffee in coffee grinders according to claim 2 wherein the components of the apparatus are as illustrated in FIG. 1, FIG. 2 and FIG. 3 and described in detailed descriptions of FIG. 1, FIG. 2 and FIG. 3.
